(19) United States
(12) Patent Application Publication
(10) Pub. No.: US 2002/0150664 A1
(43) Pub. Date: Oct. 17, 2002

(54) Frozen dessert distribution and serving system and associated methods

(76) Inventors: Eric R. Miller, Deland, FL (US); William Brown, Orlando, FL (US)

Correspondence Address: Allen, Dyer, Doppelt,, Milbrath & Gilchrist, P.A., 255 South Orange Avenue, Suite 1401, P.O. Box 3791, Orlando, FL, 32802-3791, US

(21) Appl. No.: 10/062,183

(22) Filed: Jan. 31, 2002

Related U.S. Application Data
(60) Provisional application No. 60/265,524, filed on Jan. 31, 2001.

(51) Int. Cl. A23G 9/00

(52) U.S. Cl. 426/565

(57) ABSTRACT

A method for serving a frozen dessert includes receiving a prepackaged frozen dessert at a food outlet at a storage temperature selected for optimal retention of food characteristics. The frozen dessert is placed in a tempering freezer that is adapted to maintain a serving temperature selected for optimal consumer satisfaction, which is higher than the storage temperature. The frozen dessert is retained in the tempering freezer for a sufficient time to permit the frozen dessert to equilibrate to the serving temperature. Finally, the frozen dessert is removed from the tempering freezer and served to a customer. A method for increasing a distribution potential of a frozen dessert includes prepackaging a frozen dessert at a packaging location and delivering the frozen dessert to a food outlet. Prior to the delivery, the food outlet is provided with a tempering freezer, for example, in return for a purchasing contract with the distributor.

### CROSS-REFERENCE TO RELATED APPLICATION

This application claims priority to provisional application No. 60/265,524, “Apparatus and Methods for Providing Prepackaged and Pre-flavored Comestible Products,” filed Jan. 31, 2002.

### BACKGROUND OF THE INVENTION

1. Field of the Invention

The present invention relates to a prepackaged comestible product, a process of making, distributing, and serving the product, as well as a method for conducting business.

2. Related Art

Until the present time, many food service outlets have been unable to serve a frozen dessert because of the high cost of equipment and the labor required for making such products without costly equipment. For example, typically, frozen dessert products must be distributed at minus 10 degrees Fahrenheit (−10° F.), which limits distribution to dedicated ice cream distributors.

It is known in the art to “temper” a frozen comestible, that is, to raise the temperature of the product from a storage temperature to a serving temperature higher than the storage temperature. This process is desirable to customer acceptance and satisfaction. In the past, it has been attempted to achieve a desirable serving temperature by using a microwave oven. However, this is generally unacceptable, as the microwaving process degrades the quality of the product as a result of inconsistency of heat distribution.

Furthermore, serving temperatures vary depending on the type of comestible product. For example, a shake should be served at 20-24° F.; if it is served at a temperature below 20° F., the customer will not receive the full sensory benefit of the flavor. Conversely, if it is served above 24° F., the customer will find the taste too intense. Each style of frozen comestible product has a preferred or ideal serving temperature, which cannot be consistently achieved by methods currently known in the art.

### SUMMARY OF THE INVENTION

It is therefore an object of the present invention to provide a system and method for serving a frozen dessert.

It is a further object to provide such a system and method that are economical.

It is also an object to provide such a system and method that broaden the distribution potential of a frozen dessert.

It is another object to provide such a system and method that have sufficient flexibility to enable the serving of a variety of frozen desserts.

It is an additional object to provide a method of doing business in the food service industry.

It is yet a further object to provide such a method of doing business that expands the distribution potential of frozen desserts.

These and other objects are achieved by the present invention, a first aspect of which includes a system and method for serving a frozen dessert such as a shake or a fruit-based smoothie economically and effectively. The method of this embodiment of the invention comprises the steps of receiving a prepackaged frozen dessert at a food outlet. The frozen dessert is preferably delivered at a storage temperature selected for optimal retention of food characteristics. The frozen dessert is placed in a tempering freezer at the food outlet. The tempering freezer is adapted to maintain a serving temperature selected for optimal consumer satisfaction, which is higher than the storage temperature. The frozen dessert is retained in the tempering freezer for a sufficient time to permit the frozen dessert to equilibrate to the serving temperature. Finally, the frozen dessert is removed from the tempering freezer and served to a customer, either by an employee or via self-service.

Another aspect of the present invention includes a method of doing business, which here is for increasing a distribution potential of a frozen dessert. This embodiment of the method comprises the steps of prepackaging a frozen dessert at a packaging location and delivering the frozen dessert to a food outlet remote from the packaging location. During transport the frozen dessert is preferably maintained at a desired storage temperature selected for optimal retention of food characteristics.

Prior to the delivery, the food outlet is provided, for example, by the distributor, with a tempering freezer. The tempering freezer is adapted to maintain a serving temperature that is selected for optimal consumer satisfaction, which is higher than the storage temperature. As above, the frozen dessert is placed in the tempering freezer at the food outlet for a sufficient time to permit the frozen dessert to equilibrate to the serving temperature. Once the frozen dessert has reached the serving temperature, it may be removed from the tempering freezer and served to a customer.

### DETAILED DESCRIPTION OF THE PREFERRED EMBODIMENTS

In the present invention, the frozen dessert is packed in a serving container that ultimately will be served to a consumer. Flavor may be added during production at a licensed dairy plant as desired, or flavored syrup may be added manually by an employee at the food service outlet or via a soft-serve machine. The frozen dessert comprises certain stabilizing agents that allow the comestible product to be distributed to the food service outlet at temperatures up to −15° F., which enables a distributor to deliver the product to an individual food service outlet. The higher temperature is desirable to the commercial effectiveness of this type of product, as food service outlets concentrate purchasing through one distributor to obtain the lowest distribution costs. These distributors deliver frozen products at between 0 and 15° F. Customized packing equipment is preferably used to fill and seal the product in the serving container.

By way of example, the frozen comestible product is packaged in a bulk shipping container at the dairy plant, typically 36 units per container. These containers are palletized for bulk distribution and delivered frozen at −10° F. to the food outlet. The distributor delivers the number of bulk containers requested by the food service outlet at a temperature in a range of approximately 0-15° F. The food outlet stores the bulk containers in its bulk frozen storage area. The frozen comestible product in the serving container is removed from the bulk shipping container and placed in a customized tempering freezer provided, for example, at no charge to the food outlet. The tempering freezer raises the temperature of the product to a desired serving temperature. The desired serving temperature varies depending on the required texture and flavor properties of the type of frozen comestible product. The desired properties of the frozen comestible product will also vary the length of time required to raise the temperature of the frozen comestible product stored in the bulk frozen storage area to the desired temperature to be served to the food service outlet's customers. The desired serving temperature is determined for each style of frozen comestible product through a combination of new research and reference to existing industry standards for frozen comestible products. The invention is sufficiently flexible to allow food service outlets to offer a wide variety of frozen comestible products using the method of the present invention.

Once the frozen comestible product has reached an optimal serving temperature range, thereby completing the tempering process, the food service outlet is able to serve the product to the customer. When a customer places an order, the sales/service personnel receive payment and hand the customer the comestible product and either a spoon or a straw. In outlets with minimal staffing, such as convenience stores, the customer receives a spoon or a straw and then retrieve the comestible flavor from the custom freezer him- or herself. The customer selects a desired flavor, for example, by viewing the product in the serving container through a glass cover on the customized tempering freezer, the product preferably bearing identifying indicia commensurate with the flavors and the type of comestible product available.

In the business method of the present invention, the distributor provides the tempering freezers at no cost to the food outlet in return for a purchasing agreement. As an example, a long-term, such as multiyear, agreement may be entered into for the food outlet to purchase the comestible product. The present invention addressed the difficulties experienced heretofore in serving this type of comestible product, broadening and enhancing the commercial viability of frozen dessert sales. Exemplary food outlets having the potential to benefit from the present invention include schools, hospitals, convenience stores, contract feeders, recreational facilities, stadia, and hotels.

By way of example, the frozen dessert may comprise such products as milkshakes, malts, fruit shakes, health shakes, smoothies, and soft-serve sundaes and cones. Each product includes the appropriate stabilizer ingredients to ensure a desirable handling through distribution in a temperature range of approximately 0-15° F. and the desired texture and flavor characteristics after completion of the tempering process. A flavor or flavors are added to a frozen dessert base during production at a licensed dairy plant.

At present, few dairies are able to produce these products due to the rapid hardening requirements needed to create a high-quality prepackaged product. For example, a licensed dairy must have a vertical refrigeration tunnel to meet hardening standards. The present inventors have developed customized packing equipment that can handle a variety of container sizes and heat seal the container after each has been filled.

Another embodiment of the present invention includes freezers to meet the desired tempering specifications and to satisfy volume demands of different food service outlets.

What is claimed is:

1. A method of serving a frozen dessert comprising the steps of:
receiving a prepackaged frozen dessert at a food outlet, the frozen dessert delivered at a storage temperature selected for optimal retention of food characteristics;
placing the frozen dessert in a tempering freezer at the food outlet, the tempering freezer adapted to maintain a serving temperature selected for optimal consumer satisfaction, the serving temperature higher than the storage temperature;
retaining the frozen dessert in the tempering freezer for a sufficient time to permit the frozen dessert to equilibrate to the serving temperature; and
serving the frozen dessert from the tempering freezer to a customer.

2. The method recited in claim 1, further comprising the step, following the receiving step and prior to the placing step, of storing the frozen dessert in a storage freezer at the food outlet for retaining the frozen dessert at the storage temperature.

3. The method recited in claim 1, wherein the storage temperature is in a range of approximately −20 to +15° F.

4. The method recited in claim 1, wherein the serving temperature is in a range of approximately 15 to 30° F.

5. A system for serving a frozen dessert to a consumer at a food outlet comprising:
a storage freezer for storing a frozen dessert at a storage temperature selected for optimal retention of food characteristics; and
a tempering freezer at the food outlet for permitting the frozen dessert to equilibrate therein, the tempering freezer adapted to maintain a serving temperature selected for optimal consumer satisfaction, the serving temperature higher than the storage temperature.

6. The system recited in claim 5, wherein the storage temperature is in a range of approximately −20 to +15° F.

7. The system recited in claim 5, wherein the serving temperature is in a range of approximately 15 to 30° F.

8. A method of increasing a distribution potential of a frozen dessert comprising the steps of:
prepackaging a frozen dessert at a packaging location;
delivering the frozen dessert to a food outlet remote from the packaging location, the frozen dessert maintained at a desired storage temperature selected for optimal retention of food characteristics;
providing the food outlet with a tempering freezer, the tempering freezer adapted to maintain a serving temperature selected for optimal consumer satisfaction, the serving temperature higher than the storage temperature;
placing the frozen dessert in the tempering freezer at the food outlet for a sufficient time to permit the frozen dessert to equilibrate to the serving temperature; and
serving the frozen dessert from the tempering freezer to a customer.

9. The method recited in claim 8, further comprising the step, following the delivering step and prior to the placing step, of storing the frozen dessert in a storage freezer at the food outlet for retaining the frozen dessert at the storage temperature.

10. The method recited in claim 8, wherein the storage temperature is in a range of approximately −20 to +15° F.

11. The method recited in claim 8, wherein the serving temperature is in a range of approximately 15 to 30° F.
